(19) United States
(12) Patent Application Publication
(10) Pub. No.: US 2018/0083265 A1
(43) Pub. Date: Mar. 22, 2018

(54) METHOD FOR DETERMINING STATE OF CHARGE IN LITHIUM BATTERIES THROUGH USE OF A NOVEL ELECTRODE

(71) Applicants: Mohit Singh, Santa Clara, CA (US); Xiao-Liang Wang, San Leandro, CA (US)

(72) Inventors: Mohit Singh, Santa Clara, CA (US); Xiao-Liang Wang, San Leandro, CA (US)

(73) Assignee: Seeo, Inc., Hayward, CA (US)

(21) Appl. No.: 15/825,090

(22) Filed: Nov. 28, 2017

Related U.S. Application Data
(63) Continuation of application No. 13/921,021, filed on Jun. 18, 2013.

(51) Int. Cl. H01M 4/136; H01M 10/48; H01M 4/58; H01M 10/0525; H01M 4/131; H01M 4/36

(52) U.S. Cl. CPC H01M 4/136; Y02T 10/7011; H01M 10/48; H01M 4/5825; H01M 4/364; Y10T 29/49004; H01M 10/0525; H01M 4/131

(57) ABSTRACT

The accurate determination of the state-of-charge (SOC) of batteries is an important element of battery management. One method to determine SOC is to measure the voltage of the cell and exploiting the correlation between voltage and SOC. For electrodes with sloped charge/discharge profiles, this is a good method. However, for batteries with lithium iron phosphate (LFP) cathodes the charge/discharge profile is flat. Now, by using the materials and methods disclosed herein, an amount of cathode active material that has a sloped charge/discharge profile is mixed with LFP in a cathode, which results in a charge/discharge profile with enough slope that the SOC of the battery can be determined by measuring the voltage alone.

### CROSS-REFERENCE TO RELATED APPLICATIONS

This application is a continuation of U.S. patent application Ser. No. 13/921,021, filed Jun. 18, 2013, which is incorporated by reference herein.

### STATEMENT OF GOVERNMENT SUPPORT

The invention described and claimed herein was made in part utilizing funds supplied by the U.S. Department of Energy under Contract No. DE-EE0005449. The Government has certain rights in this invention.

### BACKGROUND OF THE INVENTION

### Field of the Invention

This invention relates generally to determining state of charge for lithium batteries, and, more specifically, to novel new cathodes that make it easier to determine state of charge of such batteries.

State of charge (SOC) is the equivalent of a fuel gauge for the battery pack in a battery electric vehicle (BEV), hybrid vehicle (HEV), or plug-in hybrid electric vehicle (PHEV). The units of SOC are percentage points (0%=empty; 100%=full). An alternate form of the same measure is the depth of discharge (DoD), the inverse of SOC (100%=empty; 15%=full). SOC is normally used when discussing the current state of a battery in use, while DoD is most often seen when discussing the lifetime of the battery after repeated use.

For lithium batteries, one conventional method to determine the SOC is current integration (also known as current accounting or Coulomb counting), which calculates the SOC by measuring the battery current and integrating it over time. Thus, the passed charge (or Coulombs) can be calculated and compared with the nominal capacity of the battery, leading to a SOC determination.

The SOC results from such current integration methods may be in error due to several things that can affect the SOC such as operation history, long-term drift, lack of a reference point, and, uncertainties about cell total accessible capacity which changes as the cell ages. In addition, the efficiency of the battery is less than 100% and measurement errors accumulate over time. Only fully-charged or fully-discharged cells have well-defined SOCs (100% and 15%, respectively).

Another method to determine the SOC is the voltage method. The voltage of the battery is read and then converted into the SOC via the open-circuit-voltage (OCV) curve of the battery. Such a conversion can take into account the capacity fading and the efficiency of the battery. Also, the method is not subject to long-term drift issues nor does it need a reference point. On the other hand, this method requires that the battery have charge/discharge curves with suitable slopes, so that each SOC can be related to a specific voltage.

For some battery chemistries, voltage does not decrease continuously during discharge. For example, in a cell with a lithium metal anode and a LiFePO₄ (LFP) cathode, voltage decreases at the very beginning of discharge and then remains stable throughout the majority of the discharge until it finally drops at the end. As the cell continues to discharge, the SOC decreases, but the voltage remains near constant. Such a relatively flat voltage curve is not useful in trying to determine the SOC of such a cell using the voltage method as the charge/discharge curves may erroneously indicate the same SOC over a wide range of voltage.

What is needed is a simple, direct, accurate method to determine the SOC for rechargeable batteries with LFP-based cathodes.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic drawing of a cathode for an electrochemical cell, according to an embodiment of the invention.

FIG. 2 is a graph that shows charge/discharge profiles for batteries with V₂O₅ cathodes and with LFP cathodes.

FIG. 3 is a graph that shows open-circuit-voltage (OCV) profiles for batteries with LFP/V₂O₅ cathodes and with a LFP cathode.

FIG. 4 is a graph that shows capacity access as a function of cycle number for batteries with LPF/V₂O₅ cathodes.

FIG. 5 is a schematic drawing of an electrochemical cell that has a novel cathode, according to an embodiment of the invention.

### SUMMARY

A new cathode for an electrochemical cell is disclosed. The cathode has LFP active material particles mixed with particles of a second active material. The second cathode active material has an open circuit voltage change of at least 10 mV as SOC changes from 100% to 15%. In one arrangement, the second cathode active material has an open circuit voltage change of at least 5 mV as SOC changes from 100% to 15%. The cathode also contains an electrolyte. The electrolyte may be a solid or a gel, in which case, it is included as part of the initial cathode fabrication. The electrolyte may be a liquid, in which case, it may be added after initial cathode fabrication to fill voids in the cathode. There may also be carbon particles mixed together with the LPF particles and the second active material particles to form the cathode

Examples of useful materials for use as the second active material, include, but are not limited to, FeS₂, FeOF, FeF₃, FeF₂ and MoO₃, sulfur, CuO, Cu₂O, FeO, Fe₂O₃, V₆O₁₃, VO₂, Li₁₊ₓV₃O₈ (0≦x≦3), AgₓV₂O₅ (0<x≦2), CuₓV₄O₁₁ (0<x≦3), and VOPO₄.

In some arrangements, the second cathode active material particles compose between about 0.1 wt % and 50 wt %, between about 0.5 wt % and 25 wt %, or between about 2 wt % and 10 wt % of the total amount of cathode active material in the cathode.

In one embodiment of the invention, a battery cell has a cathode as described above, a first electrolyte in the cathode, a Li metal anode, and a separator between the cathode and the anode, the separator comprising a second electrolyte. In one arrangement, the first electrolyte and the second electrolyte are the same. One or both electrolytes may be solid, gel, or liquid.

In another embodiment of the invention, a method of determining SOC for a lithium battery that has a LFP-based cathode is disclosed. The method involves providing a cathode comprising LFP particles and particles made from a material that has an open circuit voltage change of at least 10 mV as SOC changes from 100% to 15%; forming a lithium battery cell comprising the cathode, a Li metal anode and a second electrolyte; measuring an OCV for the cell; and comparing the OCV to a previously-obtained correlation between OCV and SOC to determine the SOC.

### DETAILED DESCRIPTION

The preferred embodiments are illustrated in the context of cathodes for lithium batteries.

In this disclosure, the terms “positive electrode” and “cathode” are both used to mean “positive electrode.”

A novel cathode has been developed. The cathode makes it possible to use the voltage method to determine the SOC of lithium batteries that have LFP-based cathodes. Heretofore it has not been possible to use the voltage method to determine the SOC of such batteries as the voltage remains near constant over most of the charge/discharge curves.

But LFP is a very popular cathode material in lithium batteries. It has unparalleled long life and is extremely safe to use because of its stable crystal structure. LFP cathodes are useful in increasing the energy density of lithium batteries. LFP is a low-cost material made of abundant iron and phosphorus without expensive transition metals.

In one embodiment of the invention, some amount of a second cathode material is added to a LFP-based cathode. The second cathode material is a material that has a sloped charge/discharge open circuit voltage (OCV) profile instead of the flat profile characteristic of LFP. In general, useful cathode active materials have an open circuit voltage change of at least 10 mV or at least 5 mV as SOC changes from 100% to 15%. Thus, at each SOC, the voltage of the battery is the sum of the voltages from the LFP and from the second material, adding some slope to the OCV profile. In this was the voltage does decrease (increase) with discharge (charge), and it can be used to determine SOC.

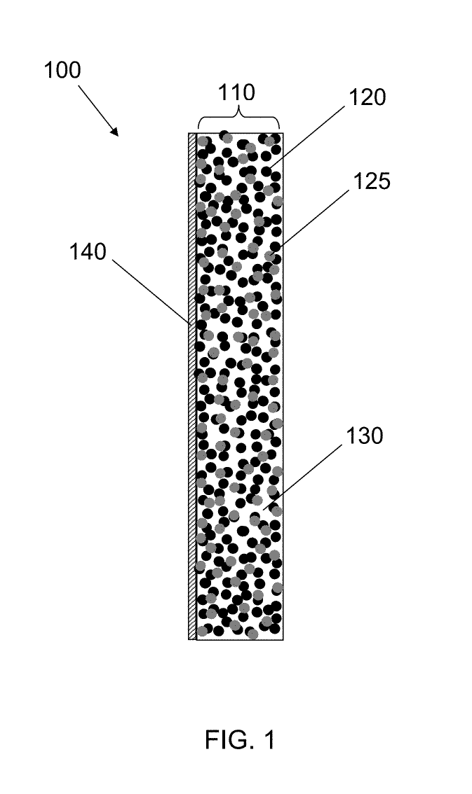

FIG. 1 is a cross-sectional schematic drawing of a cathode assembly 100 that includes a cathode film 110 and an optional current collector 140, according to an embodiment of the invention. The cathode film 110 has LFP particles 120 and cathode active materials of a second cathode active material 125, optional small, electronically-conductive particles (not shown) such as carbon black, and optional binder material (not shown) all surrounded by either a solid or gel electrolyte 130 or empty space 130 which can be filled later with a liquid electrolyte. In one embodiment of the invention, the cathode film 110 has a blend of second cathode particles not all of which are made of the same active material. Two or more different kinds of second active material can be used. Exemplary current collectors include aluminum and copper.

When a solid or gel electrolyte 130 is used, the electrolyte 130 cannot leak out of the cathode film 110, and there is no need for the current collector 140 to act as a barrier to hold liquid electrolyte within the electrode film 110. This makes it possible to use a very thin or reticulated metal current collector 140 whose only function is electronic conduction, thus reducing unnecessary weight and volume in the electrode assembly 100.

When a liquid electrolyte is used, it can be useful to form the cathode film 110 with void space 130 on the current collector 140. When a cell is made with the cathode 100, liquid electrolyte can be added to the cathode film 110 to fill the void space 130 before the cell package is sealed.

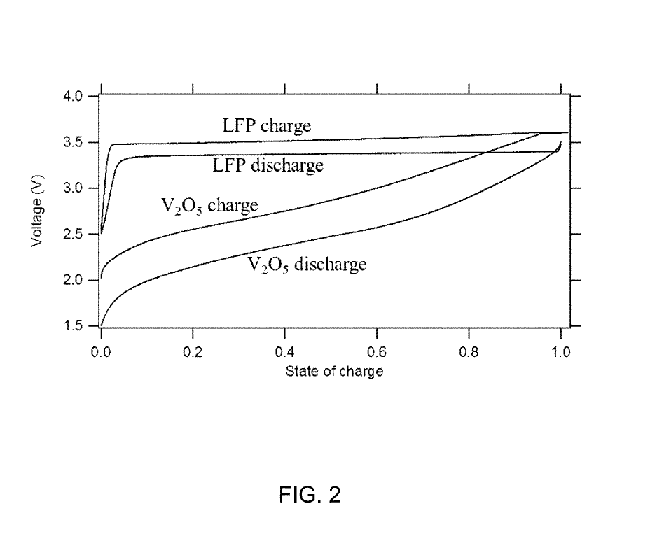

One example of a suitable second cathode material is vanadium pentoxide (V₂O₅). FIG. 2 shows a graph of voltage as a function of SOC for cells with Li metal anodes, which have a cathode that contains only LFP active material and which have a cathode that contains only V₂O₅ active material. The V₂O₅ cathode is made up of V₂O₅ powder, acetylene carbon, and catholyte with a composition of 78/2/20 by weight. The catholyte is ethylene oxide polymer and lithium salt. The cells with the V₂O₅ cathode were cycled between 1.5V and 3.6V, and the charge/discharge profiles were obtained.

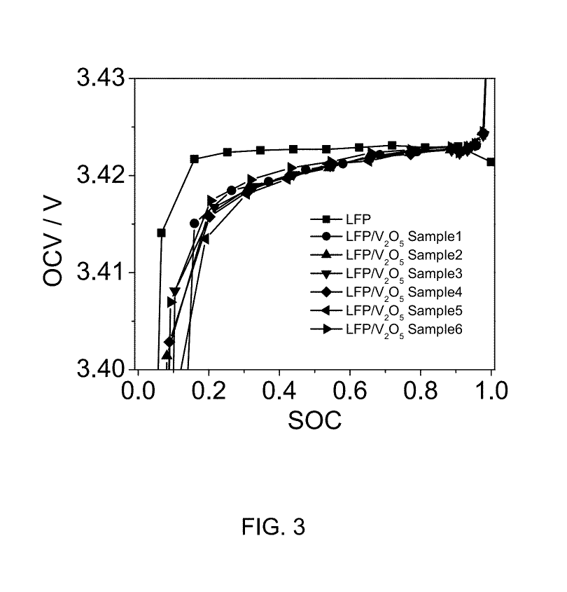

FIG. 3 is a graph that shows the open-circuit-voltage (OCV) profiles of battery cells with Li metal anodes and cathodes that contain a mixture of LPF and V₂O₅ in a weight ratio of about 94:6. The OCV profile of the cell with a cathode that contains only LPF is also shown for comparison. In the SOC range where the OCV of the battery that contains only LFP is flat (between about 0.15-1 SOC), the battery with the LPF/V₂O₅ composite cathode shows a change in voltage of about 10 mV. The voltage profile of the battery with the LPF/V₂O₅ composite cathode has enough slope that SOC can be determined accurately from voltage values alone.

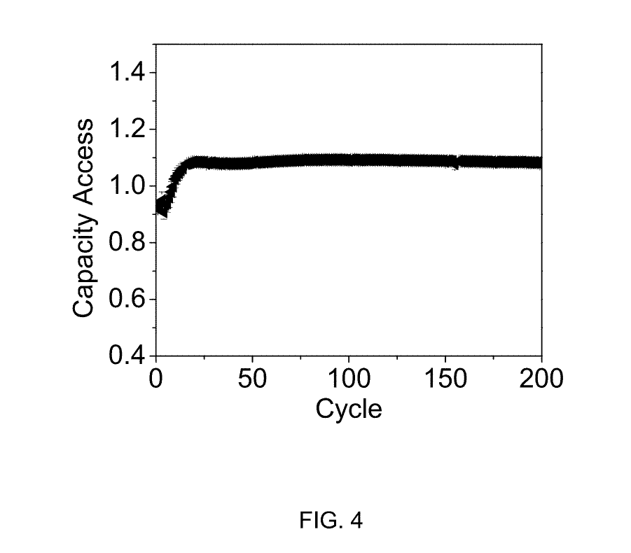

FIG. 4 shows capacity as a function of cycle number for the cells with a Li metal anode and a LPF/V₂O₅ (94:6 wt) composite cathode. Clearly, the capacity is very stable for at least the first 200 cycles with no indication of fading.

In general, useful cathode active materials are those that can absorb and release Li ions and that have an open circuit voltage change of at least 10 mV as SOC changes from 100% to 15%. In one arrangement, the cathode active materials can absorb and release Li ions and have an open circuit voltage change of at least 5 mV as SOC changes from 100% to 15%. Examples of useful second cathode material include, but are not limited to, any one of FeS₂, FeOF, FeF₃, FeF₂ and MoO₃, sulfur, CuO, Cu₂O, FeO, Fe₂O₃, V₆O₁₃, VO₂, Li₁₊ₓV₃O₈ (0≦x≦3), AgₓV₂O₅ (0<x≦2), CuₓV₄O₁₁ (0<x≦3), VOPO₄, and mixtures thereof.

In one embodiment of the invention, a novel new cathode is prepared by making a slurry of LFP particles, second cathode material particles, carbon (optionally), and solid or gel electrolyte. In one embodiment of the invention, a novel new cathode is prepared by making a slurry of LFP particles, a blend of second cathode material particles not all of which are made of the same active material, carbon (optionally), and solid or gel electrolyte. Two or more different kinds of second active material can be used. In one arrangement, the electrolyte is a solid electrolyte. In one arrangement, the electrolyte is a block copolymer electrolyte. In other arrangements, the electrolyte is a gel. In some arrangements, the electrolyte also contains a salt, such as a lithium salt. After the slurry is homogenized, the slurry is either extruded or coated onto a metal foil and is then dried.

In one embodiment of the invention, a liquid electrolyte is used with the cathodes described herein. Such cathodes are prepared by making a slurry of LFP particles, second cathode material particles, carbon (optionally), and binder material. In one embodiment of the invention, a novel cathode is prepared by making a slurry of LFP particles, a blend of second cathode material particles not all of which are made of the same active material, carbon (optionally), and binder material. Two or more different kinds of second active material can be used. After the slurry is homogenized, the slurry is either extruded or coated onto a metal foil and is then dried. Once the cathode is incorporated into a cell, liquid electrolyte can be added. The liquid electrolyte may contain a salt, such as a lithium salt.

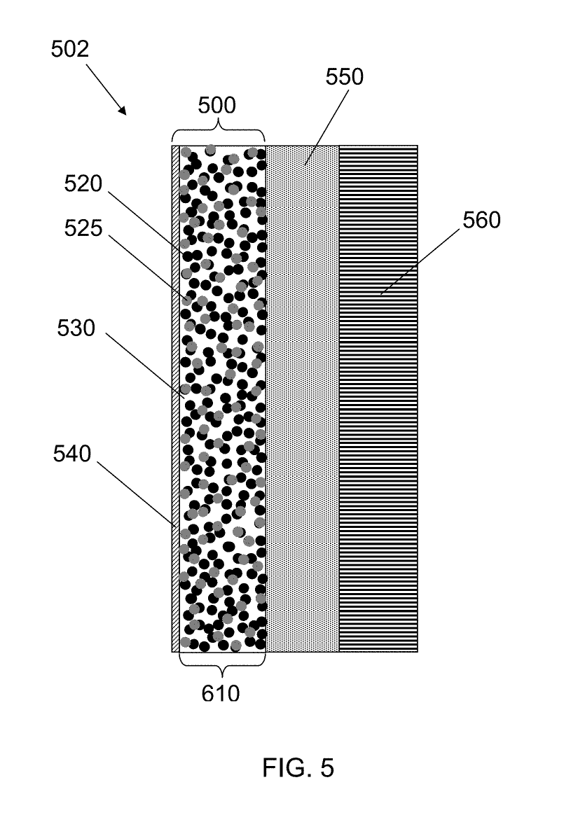

FIG. 5 is a cross-sectional schematic drawing of an electrochemical cell 602 with a positive electrode assembly 600 as described above FIG. 1, according to an embodiment of the invention. The positive electrode assembly 600 has a positive electrode film 610 and an optional current collector 640. The cathode film 610 has LFP particles 620 and cathode active materials of a second cathode active material 625, optionally small, electronically-conductive particles (not shown) such as carbon black, and optionally binder material (not shown) all surrounded by either a solid or gel electrolyte 630 or empty space 630 which can be filled later with a liquid electrolyte. In one embodiment of the invention, the cathode film 610 has a blend of second cathode material particles not all of which are made of the same active material. Two or more different kinds of second active material can be used.

There is a positive electrode current collector 640 that may be a continuous or reticulated metal film as described above. In one arrangement, there is a negative electrode 660 that is a metal layer, such as a lithium layer, that acts as both negative electrode active material and negative electrode current collector. In another arrangement, there is a negative electrode 660 that is a silicon-based or carbon-based material and a negative electrode current collector (not shown). There is a separator region 650 filled with an electrolyte that provides ionic communication between the positive electrode film 610 and the negative electrode 660. In one arrangement, the separator region 650 contains a solid electrolyte and can be the same solid electrolyte as is used in the positive electrode film 610.

Any electrolyte appropriate for use in a lithium battery cell can be used in the embodiments of the invention. In one arrangement, more than one electrolyte is used. For example, a first electrolyte may be used as a catholyte and a second electrolyte may be used in the separator of the cell. In order to avoid mixing of the electrolytes, it can be helpful if at least one of the electrolytes is solid or a gel. Examples of appropriate liquid electrolytes include, but are not limited to polymers such as: polyethylene oxide, polypropylene oxide, polyethylene oxide, polystyrene, polyvinyldifluoride, polyacrylonitrile, carboxymethyl cellulose, styrene-butadiene rubber, polyacrylic acid, polyvinyl carbonate, polymethyl methacrylate, and polysiloxane. The polymer(s) can be dissolved in solvents such as: ethylene carbonate, propylene carbonate, dimethyl carbonate, diethyl carbonate, ethyl methyl carbonate, and vinylene carbonate. Lithium salts can be added. Examples include: lithium bis(trifluoromethanesulphonil) imide, lithium bis(oxalate)borate, lithium tetrafluoroborate, lithium hexafluorophosphate and lithium bis(pentafluoroethanesulfonyl)imide.

Solid electrolytes, such as solid polymer electrolytes may also be used. In one arrangement, a block copolymer electrolyte is used. It includes an ionically-conductive phase and a structural phase so that overall the block copolymer electrolyte has a modulus greater than about 1×10⁵ Pa at 25° C. In some arrangements, the block copolymer electrolyte has a modulus greater than about 1×10⁶ Pa at 25° C. In some arrangements, the block copolymer electrolyte has a modulus greater than about 1×10⁷ Pa at 25° C.

In one embodiment of the invention, the conductive phase can be made of a linear or branched polymer. Conductive linear or branched polymers that can be used in the conductive phase include, but are not limited to, polyethers, polyamines, polyimides, polyamides, alkyl carbonates, polynitriles, and combinations thereof. The conductive linear or branched polymers can also be used in combination with polysiloxanes, polyphosphazines, polyolefins, and/or polydienes to form the conductive phase.

In another exemplary embodiment, the conductive phase is made of comb (or branched)polymers that have a backbone and pendant groups. Backbones that can be used in these polymers include, but are not limited to, polysiloxanes, polyphosphazines, polyethers, polydienes, polyolefins, polyacrylates, polymethacrylates, and combinations thereof. Pendants that can be used include, but are not limited to, oligoethers, substituted oligoethers, nitrile groups, sulfones, thiols, polyethers, polyamines, polyimides, polyamides, alkyl carbonates, polynitriles, other polar groups, and combinations thereof.

In one embodiment of the invention, the structural phase can be made of polymers such as polystyrene, hydrogenated polystyrene, polymethacrylate, poly(methyl methacrylate), polyvinylpyridine, polyvinylcyclohexane, polyimide, polyamide, polypropylene, poly (2,6-dimethyl-1,4-phenylene oxide) (PXE), polyolefins, poly(t-butyl vinyl ether), poly(cyclohexyl methacrylate), poly(cyclohexyl vinyl ether), poly(t-butyl vinyl ether), polyethylene, fluorocarbons, such as polyvinylidene fluoride, or copolymers that contain styrene, methacrylate, or vinylpyridine.

It should be noted that use of such second active materials in the cathode of a lithium battery cell is especially useful for Li metal batteries as opposed to Li ion batteries. In general, Li-ion batteries use carbon-based anodes and rely on lithium in the active cathode material as a source of Li ions to cycle back and forth from cathode to anode. An additional active material that does not contain lithium in the cathode is essentially dead weight as there is no additional Li available to be absorbed and released from such active material. On the other hand, Li metal battery cells use Li metal as the anode material, so there is a plentiful supply of Li within the cell. Added cathode material that does not, itself, contain Li is still a useful cathode active material and can easily participate in the electrochemical processes of the cell. Nevertheless, it is within the scope of the invention as described herein to use the novel cathodes in lithium ion batteries with carbon-based or silicon-based anodes.

In another embodiment of the invention, a method is provided to measure SOC in cells that employ the novel cathode described above. Preliminary data is gathered by discharging (or charging) a cell and measuring the OCV at various points during the discharge (charge). At the same points SOC is known as the amount of charge that has gone out of (into) the cell has been recorded (Coulomb counting method). Correlations are made between the OCV and the SOC values. As the cell is subsequently discharged (charged), the OCV is measured as desired and the values are compared to the previously-obtained correlation between OCV and SOC to determine the SOC.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A cathode for an electrochemical cell comprising:
first cathode active material particles, wherein the first cathode active material is LFP;
second cathode active material particles, wherein the second cathode active material is one or more selected from the group consisting of FeOF, FeF₃, FeF₂ and sulfur, FeO, Fe₂O₃, V₆O₁₃, VO₂, Li₁₊ₓV₃O₈ (0≦x≦3), AgₓV₂O₅ (0<x≦2), CuₓV₄O₁₁ (0<x≦3), and VOPO₄;
an electrolyte;
wherein the first cathode active material particles, the second cathode active material particles, optionally carbon particles, and the electrolyte are all mixed together to form the cathode.

2. The cathode of claim 1 wherein the second cathode active material comprises FeOF.

3. The cathode of claim 1 wherein the second cathode active material comprises FeF₃.

4. The cathode of claim 1 wherein the second cathode active material comprises FeF₂ and sulfur.

5. The cathode of claim 1 wherein the second cathode active material comprises FeO.

6. The cathode of claim 1 wherein the second cathode active material comprises Fe₂O₃.

7. The cathode of claim 1 wherein the second cathode active material comprises V₆O₁₃.

8. The cathode of claim 1 wherein the second cathode active material comprises VO₂.

9. The cathode of claim 1 wherein the second cathode active material comprises Li₁₊ₓV₃O₈ (0≦x≦3).

10. The cathode of claim 1 wherein the second cathode active material comprises AgₓV₂O₅ (0<x≦2).

11. The cathode of claim 1 wherein the second cathode active material comprises CuₓV₄O₁₁ (0<x≦3).

12. The cathode of claim 1 wherein the second cathode active material comprises VOPO₄.

13. The cathode of claim 1 wherein the second cathode active material has an open circuit voltage change of at least 5 mV as SOC changes from 100% to 15%.

14. The cathode of claim 1 wherein the second cathode active material particles compose between about 0.1 wt % and 50 wt % of the total amount of cathode active material particles.

15. The cathode of claim 1 wherein the second cathode active material particles compose between about 0.5 wt % and 25 wt % of the total amount of cathode active material in the cathode.

16. The cathode of claim 1 wherein the second cathode active material particles compose between about 2 wt % and 10 wt % of the total amount of cathode active material in the cathode.

17. A battery cell comprising:
a cathode comprising the cathode of claim 1;
an anode comprising lithium metal or alloy; and
a separator between the cathode and the anode, the separator comprising a second electrolyte.

18. The cell of claim 17 wherein the electrolyte in the cathode and the second electrolyte are the same.

19. A method of determining SOC for a lithium battery that has a LFP-based cathode, comprising:
providing a cathode comprising LFP particles and particles made from a material that has an open circuit voltage change of at least 100 mV as SOC changes from 100% to 15%;
forming a lithium battery cell comprising the cathode, a Li metal anode and a second electrolyte;
measuring an OCV for the cell; and
comparing the OCV to a previously-obtained correlation between OCV and SOC to determine the SOC.
